(19) United States
(12) Patent Application Publication
(10) Pub. No.: US 2026/0170773 A1
(43) Pub. Date: Jun. 18, 2026

(54) MANAGEMENT OF DISPLAYED CONTENT ON AN EXTENDED REALITY DEVICE

(71) Applicant: Google LLC, Mountain View, CA (US)

(72) Inventors: Eric Jordan Gonzalez, Seattle, WA (US); Esen Küçüktütüncü, Barcelona (ES); Andrea Colaco, Los Altos, CA (US); Mar Gonzalez Franco, Seattle, WA (US)

(21) Appl. No.: 19/407,963

(22) Filed: Dec. 3, 2025

Related U.S. Application Data
(60) Provisional application No. 63/733,420, filed on Dec. 12, 2024.

(51) Int. Cl. G06T 19/00; G06F 3/04815; G06F 3/04842; G06F 3/04845; G06T 19/20

(52) U.S. Cl. CPC G06T 19/006; G06F 3/04815; G06F 3/04842; G06F 3/04845; G06T 19/20; G06T 2200/24; G06T 2219/2004; G06T 2219/2016

(57) ABSTRACT

According to at least one implementation, a method includes determining a first mesh representing a first portion of a physical environment and associating a virtual object with the first mesh. The method further comprises identifying a movement associated with a selection of the virtual object. The method also provides associating, based on the movement, the virtual object with a location on a second mesh representing a second portion of the physical environment, and displaying the virtual object at the location within a display of an extended reality device.

### CROSS-REFERENCE TO RELATED APPLICATION

This application claims the benefit of U.S. Provisional Application No. 63/733,420, filed on Dec. 12, 2024, entitled “MANAGEMENT OF A SELECTOR FOR USER INPUT ON AN EXTENDED REALITY DEVICE”, the disclosure of which is incorporated herein by reference in its entirety.

### BACKGROUND

Wearable devices, such as smartwatches, smart glasses, and head-mounted displays, provide users with new ways to access and interact with digital content. Among these, extended reality (XR) devices, encompassing virtual reality (VR), augmented reality (AR), and mixed reality (MR) systems, are specifically designed to blend the physical and virtual worlds, creating immersive user experiences. A key function of these devices is to present digital content to a user in a way that is integrated with their environment.

Content can be displayed on wearable devices in various ways. For example, in augmented reality applications, digital information or virtual objects are overlaid onto the user's view of the physical world. This can be accomplished using optical see-through devices, which have transparent lenses that allow a user to view their surroundings directly while projecting digital elements into their field of view. Alternatively, video see-through devices use cameras to capture the physical environment and display it on internal screens, combining the video feed with computer-generated graphics.

### SUMMARY

This disclosure relates to systems and methods for managing virtual objects in a real-world space using an extended reality (XR) device, like smart glasses. The device first scans the user's physical environment to create a digital map of surfaces, such as walls and desks. These digital surfaces are called meshes. A user can place a virtual object, like an application window or a 3D model, onto a first surface, causing it to appear anchored there. The user can then select this object and move the object. Based on the user's movement, the system can move the virtual object from the first surface and attach it to a second, different surface. For example, a user could move a virtual video player from a wall to their desk.

When the virtual object is moved to the new surface, its orientation can be adjusted to match the new surface. For instance, an object moved from a vertical wall to a horizontal desk will reorient itself to lie flat on the desk. The system is also designed to understand the user's intent based on their gestures; a slow drag may slide an object along its current surface, while a quick pull could detach the object into free space. Additionally, the system can apply physics properties to virtual objects and surfaces. This enables a virtual object, such as a ball, to bounce realistically on a digital representation of a physical desk, with its movement influenced by properties such as friction and mass, resulting in a more intuitive and immersive experience.

In some aspects, the techniques described herein relate to a method including: determining a first mesh representing a first portion of a physical environment; associating a virtual object with the first mesh; identifying a movement associated with a selection of the virtual object; associating, based on the movement, the virtual object with a location on a second mesh representing a second portion of the physical environment; and displaying the virtual object at the location within a display of an extended reality device.

In some aspects, the techniques described herein relate to a computer-readable storage medium having program instructions stored thereon that, when executed by at least one processor, direct the at least one processor to perform a method, the method including: determining a first mesh representing a first portion of a physical environment; associating a virtual object with the first mesh; identifying a movement associated with a selection of the virtual object; associating, based on the movement, the virtual object with a location on a second mesh representing a second portion of the physical environment; and displaying the virtual object at the location within a display of an extended reality device.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method, the method including: determining a first mesh representing a first portion of a physical environment; associating a virtual object with the first mesh; identifying a movement associated with a selection of the virtual object; associating, based on the movement, the virtual object with a location on a second mesh representing a second portion of the physical environment; and displaying the virtual object at the location within a display of an extended reality device.

The accompanying drawings and the description below outline the details of one or more implementations. Other features will be apparent from the description, drawings, and claims.

### BRIEF DESCRIPTION OF THE DRAWINGS

FIG. 1 illustrates a computing environment for managing the display of virtual objects according to an implementation.

FIG. 2 illustrates an operational scenario of moving a virtual object based on the meshes according to an implementation.

FIG. 3 illustrates a method of associating objects to different meshes representing a physical environment according to an implementation.

FIG. 4 illustrates a method of identifying meshes in a physical environment according to an implementation.

FIG. 5 illustrates a method of changing a selector appearance according to an implementation.

FIG. 6 illustrates an operational scenario of moving an object in 3D space according to an implementation.

FIG. 7 illustrates an operational scenario of moving an object in 3D space according to an implementation.

FIG. 8 illustrates an operational scenario of moving a selector in a user's perspective according to an implementation.

FIG. 9 illustrates an operational scenario of moving displayed content from a display to the virtual space provided by the XR device according to an implementation.

FIG. 10 illustrates a computing system to manage the display of objects relative to a physical environment according to an implementation.

### DETAILED DESCRIPTION

The systems and techniques described herein solve a common challenge in augmented reality: making virtual objects interact with the real world in a believable way. This technology enables extended reality (XR) devices to scan and identify the surfaces in a room. The technology then uses this information to allow users to intuitively place virtual objects on real-world surfaces and move them between surfaces with simple, natural gestures, creating a seamless, immersive experience.

An extended reality (XR) device is a type of wearable computing system that modifies a user's perception of reality by merging real and virtual worlds. These devices, which include virtual reality (VR) headsets, augmented reality (AR) glasses, and mixed reality (MR) displays, are typically worn on the head to provide visual and sometimes auditory feedback, creating an immersive experience. VR devices replace the user's physical surroundings with a computer-generated environment, effectively transporting the user to a different world. In contrast, AR and MR devices enhance the user's existing environment by overlaying or integrating digital information, such as interactive 3D models, data visualizations, or navigational cues, onto their view of the physical world. The purpose of these systems is to enable users to interact with digital content in a spatially aware context, allowing for more intuitive and powerful applications in fields ranging from entertainment and gaming to professional training, remote collaboration, and complex data analysis.

To interact with the virtual objects presented by an XR device, a user typically employs a selector, which functions as a cursor in the three-dimensional space. The position and state of this selector are controlled through various input mechanisms, including handheld controllers, hand tracking, eye-gaze, and traditional peripherals such as a mouse or trackpad. The selector's visual representation can be rendered within the user's field of view, allowing them to point at, select, and manipulate virtual content. However, existing systems face significant technical challenges in managing this interaction. For instance, accurately determining the user's intended selection depth in a 3D scene using a 2D input device can be ambiguous, leading to the selector unintentionally snapping to background objects or floating in space. Furthermore, when a user is presented with a mix of 2D content (e.g., a flat application window) and 3D objects, a single selector paradigm is often inefficient, making it difficult to precisely interact with elements on the 2D surface without the selector's depth interfering. This ambiguity can lead to user frustration, reduced precision, and a degradation of the overall immersive experience.

In some technical solutions, the XR device is configured to perform spatial mapping of the user's physical environment. Using a combination of sensors, such as cameras and depth-sensing technologies like Light Detection and Ranging (LiDAR), the system scans the surroundings to capture spatial data. Computer vision algorithms process this data to construct one or more meshes, which are 3D digital representations of the real-world surfaces. Each mesh is composed of vertices, edges, and faces that define the geometry of physical objects, such as walls, floors, and desks, allowing the XR device to understand the layout and structure of the environment.

Once these environmental meshes are generated, they serve as a foundational layer for placing and manipulating virtual objects. A virtual object, such as an application window or a 3D model, can be associated with a specific mesh, causing it to be rendered as if it were resting on or attached to the corresponding physical surface. When a user provides input to move the object, the system tracks the movement and determines the user's intent. For example, a slow drag might slide the object along the surface of its current mesh, while a quick pulling motion could detach it, allowing it to move freely in 3D space. The object can then be moved and associated with a different mesh, where it will conform to the new surface's orientation and position. As used herein, a virtual object is any computer-generated entity rendered by the XR device and presented to the user within the mixed reality environment. The virtual object is defined by a set of digital attributes, including its geometry (shape and size), appearance (e.g., color, texture, and material properties), and behavior (e.g., interactivity, physics). These objects can range in complexity from simple two-dimensional (2D) elements, such as application windows (e.g., a web browser or video player), user interface widgets (e.g., buttons, sliders, and menus), or digital text and notifications. They can also be fully three-dimensional (3D) models, including static objects such as virtual furniture or architectural visualizations, as well as dynamic and interactive objects like animated characters, product prototypes, or complex data visualizations.

In some implementations, the XR device can be equipped with a suite of sensors to perform this environmental mapping. These can include one or more RGB cameras, which capture color and texture information from the surroundings, like a standard digital camera. Complementing the cameras can be depth sensors, such as Light Detection and Ranging (LiDAR) scanners or time-of-flight (ToF) cameras. These specialized sensors actively emit light (e.g., laser pulses or infrared light) and measure the time it takes for the light to reflect off surfaces and return. This measurement enables the system to calculate the precise distance to various points in the environment, generating a dense point cloud or depth map that accurately represents the space's geometry.

The data from these sensors can be fused and processed by the XR device's processing system. Using advanced algorithms, such as Simultaneous Localization and Mapping (SLAM) and computer vision, the system interprets the raw sensor data. The SLAM algorithms can be configured to track key feature points in the environment through a camera feed, simultaneously building a map of these points and determining the device's position within that map and objects within the map. The point cloud (or depth information) from the depth sensors provides the foundational geometric structure, while the image data from the RGB cameras is used to add texture, color, and help identify distinct surfaces and object boundaries. The system's software can combine this information to construct a continuous, three-dimensional digital model of the physical environment. In some examples, the process can run in real-time, allowing the mesh to be dynamically updated as the user moves through the space or as objects within the environment are rearranged.

In some implementations, alternatively, or in conjunction with these algorithms, the mesh identification process can be accomplished using a machine learning model, such as a neural network. To configure or train such a model, a dataset of sensor data, including RGB images and depth maps from a multitude of environments, can be collected and paired with corresponding high-fidelity, ground-truth 3D meshes. During training, the model learns to infer the geometric structure of surfaces directly from the raw sensor inputs by minimizing the difference between its predicted mesh and the ground-truth data. Once configured (i.e., trained), the model can be deployed on the XR device to perform real-time inference, generating an accurate environmental mesh by processing the live feed from its sensors.

As described herein, a mesh is a collection of vertices, edges, and faces that define the shape of a polyhedral object in 3D computer graphics and modeling. In the context of spatial mapping, a mesh is the digital representation of the surfaces in the physical world. The vertices are individual points in 3D space that define the corners of the geometric shapes. Edges are the line segments that connect pairs of vertices. Faces, most commonly triangles (forming a triangle mesh), are the planar surfaces enclosed by a set of connected edges. By connecting a vast number of these simple geometric primitives, the system can approximate the complex surfaces of real-world objects like walls, floors, and furniture, creating a foundational geometric framework for realistic and interactive mixed reality experiences.

For example, when a user activates their XR device in an office, the system's sensors begin to map the room. The flat surface of the user's wooden desk is identified and represented as a distinct horizontal mesh. The surrounding vertical surfaces, such as the drywall to the user's left and the glass partition in front, are each converted into their own separate, larger meshes with distinct orientations. In some examples, even smaller objects, such as the screen of a physical computer monitor on the desk, might be identified as a unique, smaller mesh. As a result, the system constructs a digital scaffold of the immediate workspace, comprising several discrete meshes that correspond to the primary surfaces, each ready to serve as a potential anchor or interactive surface for virtual content. The separation of the environment into discrete meshes can provide a critical technical advantage by allowing the system to treat each surface independently. Because each mesh has its own defined orientation, the system can automatically and correctly align virtual content. For instance, a virtual note placed on the horizontal desk mesh will be rendered lying flat, whereas if it is moved to the vertical wall mesh, it will automatically orient itself to appear upright. This distinction also allows for the application of different physics-based properties to each surface, enabling more realistic and nuanced interactions where a virtual object might slide smoothly across the desk but adhere firmly to the wall.

Once the meshes are identified for an environment, the system can be configured to display content in accordance with the meshes. Virtual content, such as application windows, interactive widgets, or 3D models, can be anchored to these meshes. When an object is associated with a particular mesh, the system renders it to appear as if it is physically present on that surface, conforming to the mesh's position, orientation, and scale. For instance, a user could launch a video player application. The application's window can be placed onto the mesh representing a living room wall, where the application window appears as a flat-screen television. As the user moves around the room, the perspective of the video player can change accordingly, maintaining the illusion that it is a fixed part of the environment. This anchoring enables a stable and intuitive placement of digital content within the user's physical space, which can then be manipulated or relocated to other surfaces.

A mesh can refer to a data structure that represents a physical surface within a three-dimensional digital environment, where the structure includes a set of interconnected geometric primitives, such as vertices and polygons, that define the surface's shape and orientation. In some implementations, a mesh can be a digital scaffold of a real-world environment generated from sensor data, which serves as a foundational layer for anchoring and interacting with virtual objects. In some implementations, a mesh can be any discrete, three-dimensional digital representation of a surface in a physical environment, which enables a computing system to understand the spatial layout of the environment for purposes of rendering and managing virtual content.

To move a virtual object from one surface to another, a user can select the object using a selector. Upon selection, the user can perform a gesture, such as dragging the object away from the surface. The system can be configured to interpret the characteristics of this movement, such as its speed and direction, to determine whether the user intends to slide the object along the current mesh or detach it completely from the mesh. If a detachment gesture is detected, the object is disassociated from its initial mesh and can be moved freely through the 3D space, independent of an environmental surface.

A selector can be a virtual tool or indicator within an extended reality environment that represents the user's point of interaction, enabling the user to point at, select, and manipulate virtual objects. In some implementations, a selector can refer to a computer-generated graphical element displayed within a user's field of view that is controlled by a user input device and serves as a proxy for the user's intent to interact with virtual content at a specific location in 3D space. In some implementations, a selector can be a dynamic visual representation within an XR environment whose position and appearance are determined by user input, and which the system uses to identify a target for user commands such as selection, movement, or manipulation.

As the user navigates the object toward a different physical surface, such as a desk represented by a second mesh, the system detects the object's proximity to this new surface. When the object is positioned over the new mesh and the user releases the selection, the system associates the object with this second mesh. Consequently, the object is rendered to conform to the properties of the new surface, appearing as if it has been physically moved from the first surface to the second. For example, a user could grab a virtual calendar that is displayed on a wall (the first mesh), pull it away into the open space of the room, and then place it down onto their desk (the second mesh), where the calendar can be reoriented to lie flat on the desk's surface.

In some implementations, the system utilizes a machine learning model to recognize various user inputs and their corresponding user intents. The model can be used to distinguish between inputs (e.g., via a gesture) that move the content on the current mesh or attempt to move the content to an alternative mesh. For instance, to configure (i.e., train) the model, a dataset can be generated by capturing a range of user inputs and their corresponding outcomes. This data can include features such as the velocity, acceleration, and trajectory of the selector's movement. Other features (or parameters) could consist of the direction of the input relative to the surface normal of the mesh and the duration or pressure of the selection gesture. Each data point can be labeled as either an on-mesh movement or a detach movement. The model, such as a classifier or a neural network, can be trained on this labeled dataset to learn the patterns associated with each intent. Once deployed, the model can perform real-time inference on new user inputs, predicting whether a gesture is intended to slide, move content along a surface, or pull it away into free space, thereby enabling a more intuitive and responsive user interaction. Similar operations can also be performed to determine when a virtual object should be associated with a new mesh. For example, as a user moves a detached object through the 3D space, the system can analyze its trajectory and proximity to other identified meshes. If the object's movement slows significantly while over a new mesh or the user performs a specific placing gesture, the model can infer the user's intent to associate the object with that new surface.

The technical effect of these processes is the creation of a robust and intuitive framework for managing virtual content within a physical space. By generating 3D meshes from sensor data, the system grounds virtual objects in the user's real environment, allowing them to be anchored to and moved between surfaces. Furthermore, the use of machine learning to interpret user intent resolves ambiguity in manipulation gestures, enabling a seamless transition between on-surface and free-space interaction. This enhances user control and precision when interacting with digital content in a mixed reality setting.

In some implementations, the system can be configured to display the selector in different formats based on whether the user is interacting with 2D content (e.g., flat applications) or 3D objects (e.g., applications associated with a particular mesh). For example, when the selector is used to point at or manipulate a 3D model in the open environment, it may be rendered as a three-dimensional ray or a volumetric pointer to provide clear depth information. When the user moves the selector over a 2D application window, such as a web browser anchored to a wall mesh, the system can automatically transform the selector's appearance into a traditional 2D arrow cursor. This visual change signals a shift in context, and the system may also constrain the selector's movement to the plane of the 2D window, allowing for precise interaction with user interface elements, such as buttons and hyperlinks, which would be difficult to target accurately with a 3D pointer. Similarly, if a user is manipulating a 3D model resting on a desk mesh, the selector might initially appear as a hand icon to facilitate sliding the object on the surface. When the user performs a gesture to lift the model off the desk, disassociating it from the mesh, the selector could transition into a three-axis gizmo. This new selector would allow for more precise translation and rotation of the object in free space before it is placed on another surface. Additionally, the change in visual appearance can clarify the available inputs or registered location associated with the object (e.g., indicating that the object is no longer associated with the mesh).

In some implementations, the system can be configured to determine physics attributes associated with a virtual object and/or mesh. As used herein, physics attributes are a set of one or more digital parameters that define the behavior of a virtual object or mesh within a physics simulation, governing how the virtual object or mesh interacts with forces and other simulated entities according to a set of physical laws. For example, these attributes can define physical properties such as mass, friction, and elasticity for a virtual object. Similarly, a mesh representing a physical surface can be assigned properties like solidity, a coefficient of friction, and bounciness. The system can then utilize a physics engine to simulate how these virtual objects interact with each other and the environmental meshes according to established physical laws, such as gravity and momentum. This allows for more realistic and intuitive interactions, where virtual objects behave in a way that is consistent with the user's expectations of the physical world.

The system can determine these physics attributes in several ways. For instance, a virtual object might be created with a default set of properties, or a user could be provided with tools to customize these values. For meshes, the system could use material recognition algorithms during the spatial mapping process to automatically assign realistic friction values. For example, a mesh identified as a glass tabletop would be given a lower friction coefficient than one identified as a carpeted floor. In some implementations, the material recognition algorithms may analyze image data from an RGB camera to extract features such as color histograms, texture patterns (e.g., wood grain, fabric weave), and specular reflection properties. A configured machine learning model can then classify the surface material based on these extracted features by comparing them to a pre-existing library of known materials, allowing it to assign a corresponding friction coefficient. For example, a user could create a virtual block and assign it a significant mass. When the user releases this block in the space above the mesh representing their physical desk, the system's physics engine would apply gravity, causing the block to fall and collide with the desk mesh. Because the desk mesh is defined as a solid surface, the block would come to rest on it rather than passing through. If the user then applies a force to the block, the block can slide across the desk with movement realistically decelerating based on the friction attribute of the desk mesh and the mass of the block itself.

By combining spatial mapping with a physics engine and context-aware object attributes, the system achieves a significant technical effect by creating a more realistic, intuitive, and predictable interaction model for the user. This integration enables virtual objects to behave in a manner consistent with the physical world, allowing them to collide with, rest upon, and slide across surfaces with appropriate friction and momentum. This solves the technical problem of interaction ambiguity common in XR systems, as the physical simulation provides clear and consistent feedback about the state and behavior of virtual objects relative to the user's actual environment. Consequently, the user can manipulate digital content with greater precision and confidence, reducing errors and frustration, and thereby enhancing the overall efficiency and immersiveness of the mixed reality experience.

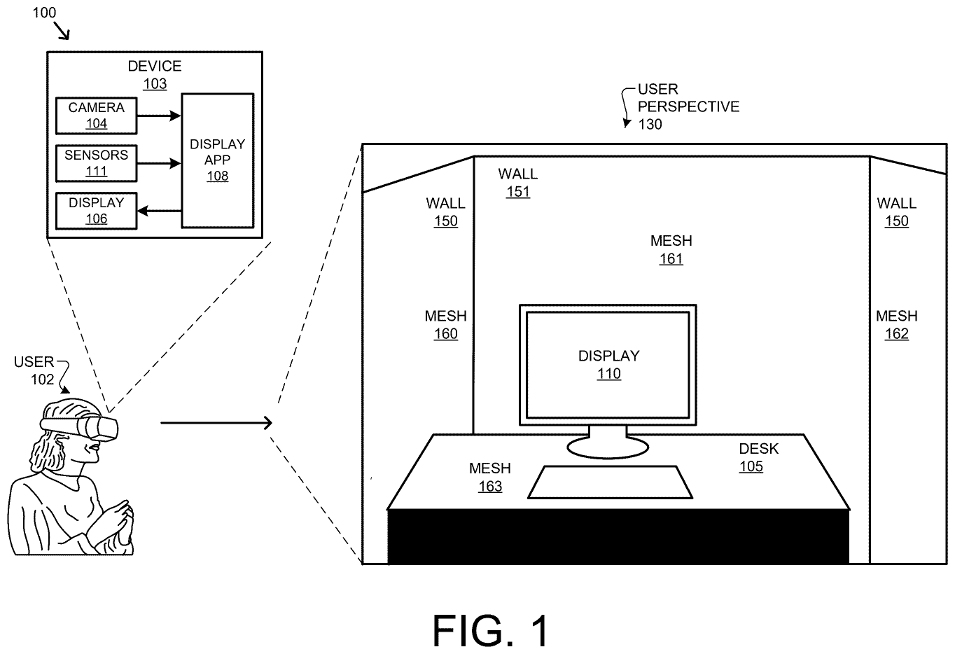

FIG. 1 illustrates a computing environment 100 for managing the display of virtual objects according to an implementation. Computing environment 100 includes user 102 and XR device 103 with camera 104, sensors 111, display 106, and display application 108. Computing environment 100 further includes user perspective 130, which corresponds to the perspective of user 102 while using device 103. User perspective 130 includes desk 105, display 110, wall 150, wall 151, wall 152, mesh 160, mesh 161, mesh 162, and mesh 163. Although demonstrated as separate meshes, multiple meshes can be combined in some examples. In some implementations, the device will determine the meshes associated with the surface of the user's physical environment. In some implementations, the meshes can be determined as part of a system that includes device 103 and one or more additional devices (e.g., a server, companion device, etc.).

In computing environment 100, the XR device 103 can be configured to utilize camera 104 and sensors 111 to perform a spatial scan of the user's environment. The camera 104 captures visual data from surfaces like desk 105 and walls 150-152, while the sensors 111 measure their geometric properties, such as distance and shape. By processing this combined information, display application 108 can generate a set of meshes, mesh 160, 161, 162, and 163, that digitally represent these physical surfaces, enabling the device to understand the room's layout. A mesh, as described herein, is a 3D digital representation of a physical environment composed of vertices, edges, and faces that define surfaces and shapes. A mesh permits XR device 103 to interpret spatial layouts, enabling interactions between virtual and real-world objects.

In some implementations, camera 104, which can be an RGB camera, obtains visual information such as color, texture, and patterns from the surfaces in the environment. Sensors 111, which can include depth-sensing technologies like LiDAR or time-of-flight cameras, capture geometric information by measuring the distance to various points on these surfaces, thereby generating a 3D point cloud or a depth map. Display application 108 can be configured to fuse these data streams in some examples. The geometric data from sensors 111 provides the foundational structure, while the visual data from camera 104 is used to identify object boundaries, differentiate between surfaces (e.g., the wood grain of desk 105 versus the painted surface of wall 150), and map textures onto the generated geometry. Using this fused information, the application constructs the individual meshes (e.g., mesh 160, 161, 162, and 163) by converting the depth information into a series of interconnected vertices, edges, and faces.

In some implementations, display application 108 can utilize a trained machine learning model to process the data streams from camera 104 and sensors 111. By analyzing the combined visual and depth information, such a model can perform semantic segmentation to identify distinct surfaces, such as desk 105 and walls 150, 151, and 152, while inferring their underlying geometric structure. The model then directly generates the corresponding mesh representations for these surfaces, effectively converting the raw sensor feed into a structured, digital map of the environment.

In some examples, the model for mesh generation can be configured (i.e., trained) using a dataset composed of paired examples, where each example includes raw sensor data (e.g., RGB images and depth maps) and a corresponding, high-fidelity ground-truth mesh of the environment. Through this configuration or training, the model learns to perform semantic segmentation on the combined data streams, identifying patterns, textures, and geometric signatures that correspond to distinct surfaces. For example, the model can be configured to differentiate a flat, horizontal wooden texture as a desk from a large, vertical, painted surface as a wall. After identifying and classifying these surfaces in the live sensor feed, the model then predicts the optimal placement of vertices, edges, and faces to construct an accurate mesh for each distinct surface.

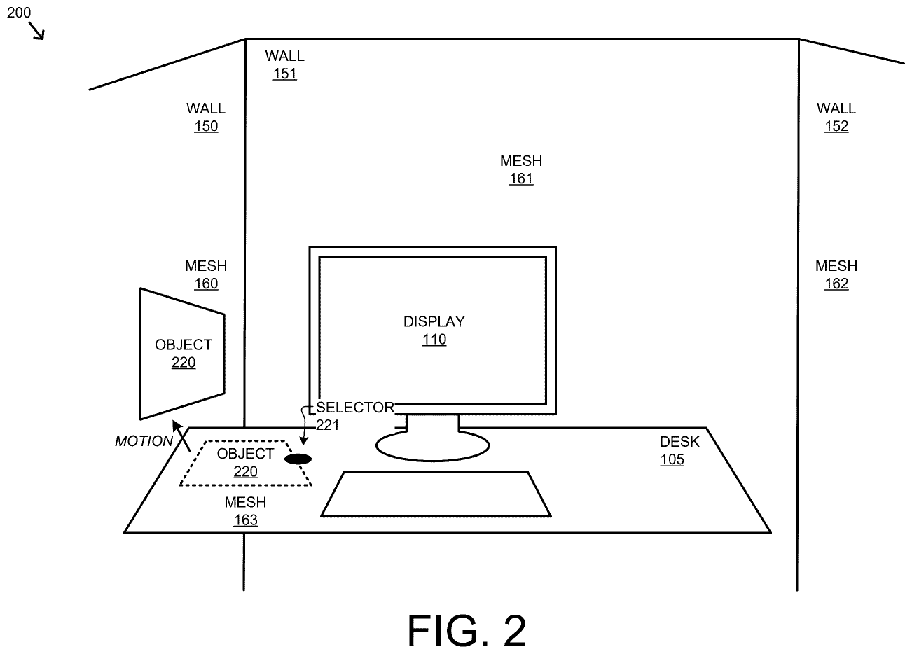

FIG. 2 illustrates an operational scenario 200 of moving a virtual object based on the meshes according to an implementation. Operational scenario 200 can be performed by a wearable device, such as XR device 103 of FIG. 1. Operational scenario 200 includes the elements user perspective 130 of FIG. 1 and further includes object 220 and selector 221.

In operational scenario 200, object 220 can initially be associated with mesh 163. For instance, object 220 could be a video player application window. When associated with mesh 163, which represents the surface of desk 105, the XR device 103 renders the video player so that the player appears to be lying flat on the physical desk. The window's orientation is aligned with the horizontal plane of the desk, and the position is constrained to the boundaries of mesh 163. As user 102 moves their head or changes their viewing angle, the perspective of the video player window adjusts accordingly, maintaining the persistent illusion that it is a digital screen physically present on the desk's surface.

As referred to herein, associating a virtual object with a mesh refers to the process of computationally binding the virtual object's spatial properties—specifically its position, rotation, and scale—to the geometric data of a particular mesh that represents a real-world surface. This binding establishes a parent-child relationship in the scene's spatial hierarchy, where the mesh acts as the coordinate space for the virtual object. The XR system's rendering engine uses this relationship to ensure the object is consistently displayed in a fixed position relative to the mesh, conforming to its surface topology and orientation.

This association is achieved by transforming the object's local coordinate system to align with the world-space coordinate system of the mesh. The object's orientation is typically matched to the surface normal of the mesh at the point of contact, and its movement is constrained to the two-dimensional plane defined by the mesh's faces. Consequently, any user input intended to move the object, such as a dragging gesture, is interpreted within the context of the mesh's surface, allowing the object to slide across it realistically without detaching or passing through it, unless a specific disassociation gesture is performed.

After associating object 220 with mesh 163, the user can select object 220 and move the object away from mesh 163. For example, by performing a quick upward pulling gesture with selector 221, the user can disassociate object 220 from mesh 163. The system interprets this gesture as an intent to detach the object, causing it to be rendered as a free-floating element in the 3D space, no longer constrained by the desk's surface. Alternatively, the user can move object 220 from mesh 163 and navigate object 220 toward wall 150, which is represented by mesh 161 (as demonstrated in FIG. 2). As the object approaches the wall, the system detects its proximity to mesh 161. Upon release of the selection, the system associates object 220 with mesh 160, causing it to reorient and appear as if it is mounted on the surface of wall 150.

In some implementations, the XR device can be configured with a model to infer user intent based on the selection and movement of the object. This model can be configured (i.e., trained) on a dataset of user interactions where different input gestures are captured and labeled with the corresponding intent. For instance, a user might provide input using a handheld controller, a trackpad, or through hand tracking. To move the video player along the surface of the desk, the user could select it and perform a slow, deliberate dragging motion with the selector. The model, analyzing the input's low velocity and a trajectory that remains parallel to the desk's mesh, would classify this as an on-mesh movement.

In contrast, if the user performs a quick, sharp pulling gesture away from the desk, the model can detect the high acceleration and the trajectory's vector moving away from the surface normal of the mesh, inferring an intent to detach the object and move it freely in 3D space. An object can be considered moving freely in 3D space when its transform—comprising its position, rotation, and scale—is disassociated from the local coordinate system of any specific environmental mesh. In this state, the object's movement is not constrained to a two-dimensional surface. Instead, its position is defined by three-dimensional coordinates (X, Y, Z) within the global world space of the XR environment, and its orientation can be manipulated independently of any surface normal. The user's input directly controls the object's six degrees of freedom, allowing for unconstrained translation and rotation throughout the volume of the mapped space.

In some implementations, the XR device can determine when object 220 is intended to be moved from a first mesh (e.g., mesh 163) to a second mesh (e.g., mesh 161). For example, after the object is detached, the system monitors its trajectory and proximity relative to other environmental meshes. The model can infer an intent to associate the object with a new mesh, such as mesh 161 representing wall 151, by analyzing several factors. Key indicators include the object's path intersecting with the new mesh's boundary, a significant deceleration in its movement as it hovers over the surface, or the user performing a specific placing gesture (e.g., a tap or hold). If the user then releases the selection while these conditions are met, the model predicts a high probability of an “associate” intent, causing the system to snap the object onto the new mesh and conform its orientation to that surface. In some examples, the system can monitor direct user inputs that transition the object from one mesh to the next.

Although demonstrated in the previous examples using a virtual object without physics characteristics or parameters, the system can also employ operations that identify physics based properties associated with a mesh. For instance, the system can use the data from the RGB camera to analyze the visual characteristics of a surface, such as its texture and color. A machine learning model trained on a dataset of materials can then classify the surface, automatically assigning appropriate physics attributes to the corresponding mesh. A surface identified as a wooden desk would be assigned a moderate friction coefficient and a high bounciness (restitution) value, while a mesh representing a carpeted floor would be given high friction and low bounciness.

To illustrate how these properties affect a virtual object, consider a user who creates a virtual rubber ball with a defined mass and elasticity. When the user drops the ball over the mesh for the wooden desk, the system's physics engine calculates its trajectory under gravity. Upon impact, the ball collides with the solid desk mesh, bounces several times with decreasing height based on the desk's restitution value, and eventually rolls to a stop, its deceleration governed by the desk's friction. If the user then pushes the ball so it rolls off the desk and onto the mesh for the carpet, its behavior changes. The impact with the carpet mesh results in a much smaller bounce due to the lower restitution, and the ball comes to a stop almost immediately because of the higher friction, realistically mimicking how a ball would behave on a soft surface.

In some implementations, the system can change the appearance of the selector 221 based on the mesh association of the selector (or the object being selected). For example, to provide clear visual feedback, the selector can undergo a contextual transformation. When the selector is positioned over an identified mesh, such as the surface of a physical desk, it can be rendered as a flat, circular reticle that aligns perfectly with the surface normal of the mesh. This visual change acts as an affordance, signaling to the user that any subsequent input, like a drag gesture, will be constrained to the two-dimensional plane of that desk. If the user then performs a gesture to move the selector away from the desk and into the open area of the room, the system can smoothly animate the selector's transformation from the flat circle into a three-dimensional volumetric pointer or a directional ray. This new form indicates that the selector is now in free space, disassociated from any mesh, and is capable of unconstrained movement in all three axes. As this 3D selector is moved toward a different surface, like a wall, it could project a shadow or a faint outline of the circular reticle onto the wall's mesh, providing a preview of the potential snapping location before it locks into place and once again becomes a flat disc. This dynamic change in appearance effectively communicates the selector's current state and interaction context, reducing ambiguity and improving user precision.

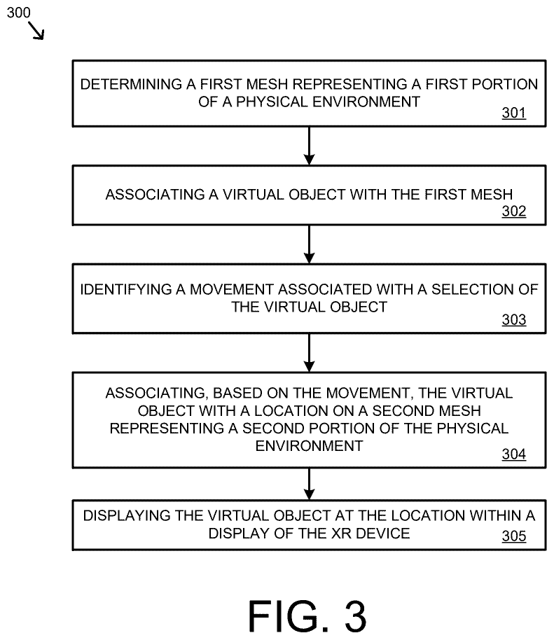

FIG. 3 illustrates method 300 of associating objects to different meshes representing a physical environment according to an implementation. Method 300 can be performed by a device, such as XR device 103 of FIG. 1.

Method 300 includes determining a first mesh representing a first portion of a physical environment at step 301. To perform this step, the XR device utilizes its onboard sensors, which can include RGB cameras and/or depth-sensing technologies like LiDAR, to perform a spatial scan of the surroundings. The cameras can capture visual information such as color and texture, and the depth sensors can measure the distance to various points on surfaces to generate a 3D point cloud (or depth information). The device's processing system can be configured to fuse these data streams and applies computer vision algorithms or a trained machine learning model to interpret the raw sensor data, thereby constructing the mesh as a digital representation of the physical surface, complete with vertices, edges, and faces that define its geometry. For example, upon scanning a physical table, the depth sensors can capture the planar geometry of its top surface, while the RGB camera can gather its wood grain texture. The system processes this fused data to generate a distinct, horizontal mesh corresponding to the tabletop.

Method 300 further includes associating a virtual object with the first mesh at step 302 and identifying a movement associated with a selection of the virtual object at step 303. To perform step 302, the system can be configured to computationally bind the virtual object's transform (i.e., its position, rotation, and scale) to the coordinate system of the first mesh. This establishes a parent-child relationship within the XR environment's spatial hierarchy, where the mesh acts as the reference frame for the object. For example, a user can place a virtual application window onto the tabletop mesh generated in step 301. The system then aligns the window's orientation with the surface normal of the mesh, causing the window to be rendered as though lying flat on the physical desk. As a result, the object appears anchored to the real-world surface, and its perspective updates correctly as the user moves.

In step 303, after the virtual object has been associated with the mesh, the system identifies a user's selection of that object and monitors the subsequent movement. The user can employ a selector, controlled by an input device such as a trackpad, hand gesture, controller, or some other input mechanism to target and select the object. Once the selection is registered, the system tracks the input characteristics, capturing data points like the velocity, acceleration, and trajectory of the selector's movement. This information is then analyzed to interpret the user's intent—for instance, a slow drag parallel to the mesh's surface is identified as an “on-mesh” movement, while a quick pulling gesture away from the surface is identified as a “detach” movement.

Method 300 further provides for associating, based on the movement, the virtual object with a location on a second mesh representing a second portion of the physical environment at step 304. Once associated, method 300 further includes displaying the virtual object at the location within a display of the extended reality device at step 305. To perform step 304, after the movement is identified as an intent to place the object on a new surface, the system first disassociates the virtual object from the first mesh. This action unbinds the object's transform from the coordinate system of the first mesh, allowing it to be re-parented. The system then identifies the target location on the second mesh, often corresponding to the point where the user's selector is positioned upon releasing the object. The association is then established by binding the virtual object's transform to the coordinate system of the second mesh. This involves updating the object's position to the target location and, critically, re-aligning its orientation to match the surface normal of the second mesh at that point. For example, if an application window is moved from a horizontal desk (the first mesh) to a vertical wall (the second mesh), its orientation is changed from lying flat to standing upright against the wall.

For step 305, the XR device's rendering engine uses the new association data to display the virtual object. The engine calculates the object's appearance from the user's current perspective, ensuring it is rendered at the correct location and with the correct orientation relative to the second mesh. By conforming the object to the geometry of the second mesh, the system creates a convincing visual illusion that the virtual object is physically resting on or attached to the real-world surface. This rendering process is continuous and updates in real-time as the user moves their head or changes their viewing angle, which maintains a stable and immersive experience where the object appears to be a fixed part of the environment.

In some implementations, the virtual object can include a 3D object (e.g., a ball) that can have physics parameters. When being bounced on a table (i.e., the first mesh), the system's physics engine uses the mesh's physics parameters (e.g., a high restitution value) to simulate a realistic, high bounce. If the ball then rolls off the table and onto a second mesh representing a carpeted floor, its behavior changes distinctly. The carpet mesh, having been assigned a low restitution value and high friction, can cause the ball to have a minimal bounce and come to a stop almost immediately, thus demonstrating how the virtual object's physical interactions are governed by the attributes of the real-world surfaces it interacts with.

In some implementations, the selector (i.e., cursor) can adapt based on the currently associated mesh or free space. For example, the selector can adapt its form based on the type of content being targeted. For instance, when the user moves the selector over a 2D application window that is anchored to a wall mesh, the system can automatically transform its appearance from a 3D pointer into a traditional 2D arrow cursor. This change not only provides a familiar visual cue but also constrains the selector's movement to the two-dimensional plane of the window, which allows for precise interaction with user interface elements that can be difficult to target accurately with a 3D pointer. Furthermore, if a user is manipulating a 3D model resting on a desk, the selector might appear as a hand icon to facilitate sliding the object on the surface. Upon lifting the model off the desk, the selector could transition into a three-axis gizmo, providing clear affordances for precise translation and rotation in free space. As a technical effect, these visual changes provide clarity to the current state of the object, clearly distinguishing the two-dimensional and three-dimensional elements of the selector and helping to improve user precision and intuitiveness.

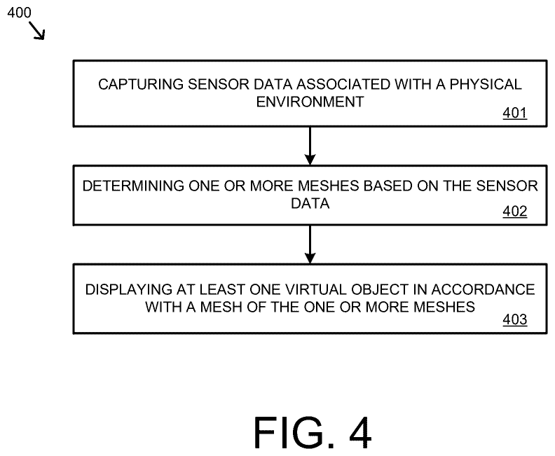

FIG. 4 illustrates method 400 of identifying meshes in a physical environment according to an implementation. Method 400 can be performed by a device, such as XR device 103 of FIG. 1.

Method 400 includes capturing sensor data associated with a physical environment at step 401. To perform this step, the XR device can be configured to use its onboard sensor suite to perform a spatial scan of the surroundings. This suite can include one or more RGB cameras to capture visual information, such as the color and texture of surfaces, and/or depth-sensing technologies, such as a LiDAR scanner or a ToF camera. The depth sensors capture geometric data by measuring the distance to various points in the environment, generating a 3D point cloud or depth map that represents the shape and layout of physical objects and surfaces.

Method 400 further includes determining two or more meshes based on the sensor data at step 402. To perform this step, the system's processing unit can be configured to combine the visual data from the RGB cameras with any geometric data from the depth sensors. Computer vision algorithms, or a trained machine learning model, then process this fused data to perform segmentation, identifying distinct surfaces within the environment. Different meshes are identified based on geometric and visual cues, such as changes in orientation, planarity, and texture. For example, the system can detect the boundary where a flat, horizontal surface (a desk) meets a large, vertical surface (a wall) as a geometric discontinuity. Similarly, a machine learning model can perform semantic segmentation to classify surfaces by type (e.g., “floor,” “wall,” “tabletop”) based on learned patterns from the sensor data. Once these distinct surfaces are identified, they are separated by generating a discrete mesh for each one. Each mesh is an independent collection of vertices, edges, and faces that represents the geometry of only its corresponding physical surface, resulting in two or more separate digital representations of the environment's components.

As a result of this process, each mesh is spatially anchored to its corresponding physical surface. For example, a mesh representing a physical table is not just a collection of shapes. The position and orientation of the mesh is locked to the table's coordinates within the XR device's map of the world. When the user moves their head, the XR device's tracking system updates the user's viewpoint in real-time. However, the coordinate system of the meshes remains fixed relative to the physical environment. Consequently, the rendering engine redraws the scene from the new perspective, but the meshes—and any virtual content associated with them—appear stable and stationary, maintaining a persistent and coherent alignment with the real world.

Once the meshes are identified, method 400 further includes displaying at least one virtual object in accordance with a mesh of the one or more messages at step 403. In some implementations, the object can be displayed in response to a user request. For instance, in response to a user's voice command to “open a browser,” the system can instantiate a new 2D virtual object representing the browser window. The system can then determine a suitable initial placement by analyzing the available meshes, selecting a large, vertically oriented surface like mesh 160 (representing wall 150) to serve as the initial anchor point. The browser window is then associated with and displayed on this mesh, appearing as if it were a screen mounted on the wall. In some examples, user preferences or application settings can be used to determine the location of the window. For example, an application can be associated with a preference to open on a vertical surface mesh (e.g., a wall). The device can identify a mesh that satisfies the preference, and display the application in accordance with the mesh.

Similarly, for a 3D object, a user could select a “create sphere” option from a virtual tool palette. In response, the system generates a 3D sphere model and, using its understanding of the environment, places it on the nearest horizontal surface, such as the desk represented by mesh 163. The sphere can then be rendered as resting on the physical desk, ready for further interaction. In some implementations, objects can be placed in a horizontal location or in space, depending on whether the object is three-dimensional. The user can then select (e.g., via a cursor) the object and move the object toward a mesh, causing the object to appear in association with the mesh visually. For example, a generated object can be moved from free space to a table.

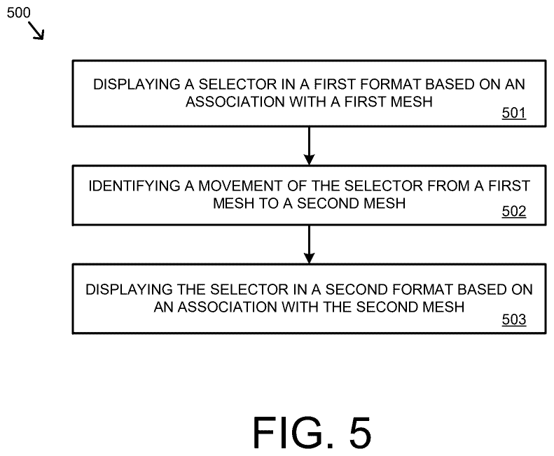

FIG. 5 illustrates method 500 of changing a selector appearance according to an implementation. Method 500 can be performed by a device, such as XR device 103 of FIG. 1.

Method 500 includes displaying a selector in a first format based on an association with a first mesh at step 501. To perform this step, the system can be configured to render the selector in a specific visual format when its position corresponds to a location on the first mesh. The association indicates that the selector's coordinate space is currently bound to the surface represented by the mesh. For example, when the user moves the selector over a first mesh representing a physical desk, the system can display the selector as a flat, circular object. This object can be oriented to lie flush against the mesh, aligning with its surface normal, which provides a clear visual affordance to the user that the selector is currently “on” the desk and that any subsequent interactions will be constrained to that two-dimensional surface.

Method 500 further includes, at step 502, identifying a movement of the selector from a first mesh to a second mesh. Based on the movement, method 500 includes displaying the selector in a second format based on an association with the second mesh at step 503. To perform step 502, the system tracks the selector's movement in 3D space. As the user moves the selector, the system detects when its projected location intersects with the geometric boundaries of the second mesh, identifying this as a transition of user intent to the new surface. In step 503, upon detecting this intersection or proximity, the system establishes a new association between the selector and the second mesh. This association computationally binds the selector's transform to the coordinate system of the second mesh. For example, if the second mesh represents a vertical wall with a different orientation from the first mesh, the selector will change its appearance to the second format. This could involve transforming from a flat circle lying on the horizontal desk (the first format) to a flat circle that is rendered upright and flush against the surface of the vertical wall, aligning with the wall's surface normal. This change provides clear visual feedback that the selector is now active on the new surface. As used herein, the format of the selector is a set of digital attributes that define its visual appearance and interactive behavior. This can include its geometry, such as changing from a two-dimensional shape (e.g., a circle or arrow) to a three-dimensional model (e.g., a ray or volumetric pointer); its orientation, which can align with the surface normal of an associated mesh; its visual properties like color, texture, and transparency; and its behavioral constraints, which can limit its movement to a two-dimensional plane or allow for unconstrained movement with multiple degrees of freedom.

In some implementations, the system can also identify a movement that disassociates the selector from any mesh, causing it to enter a free-space state. For example, if a user performs a quick pulling gesture away from the second mesh (the wall), the system can be configured to interpret this as an intent to detach. In response, the selector's format can change to a third format, for instance, transforming from the flat circle to a three-dimensional ray or volumetric pointer. This third format visually communicates that the selector is no longer bound to a surface and can move freely in all three axes within the 3D environment. The intent to move into free space can be determined by analyzing the input's characteristics, such as high velocity or acceleration in a direction perpendicular to the mesh's surface normal. Once in free space, the user can then navigate the selector toward any other identified mesh to select it for association. As the selector approaches a new surface, the system can provide a visual preview, such as projecting an outline of the on-surface format onto the mesh, before the user confirms the association. At this point, the selector can snap to the surface and adopt the appropriate on-mesh format. As a result, in some implementations, the user can manually select a mesh, and the selector can be displayed based on the association with the mesh. As described herein, association with a mesh refers to the computational binding of a virtual element's transform (i.e., its position, rotation, and scale) to the coordinate system of a specific mesh representing a physical surface. This establishes a parent-child relationship in the system's spatial hierarchy, where the mesh dictates the reference frame for the associated element. Consequently, the element's movement is constrained to the two-dimensional surface defined by the mesh's faces, and its orientation is aligned with the surface normal of the mesh. In contrast, an element that is not associated with any mesh is considered to be in “free space,” where its transform is independent of any environmental surface and can be manipulated in all six degrees of freedom.

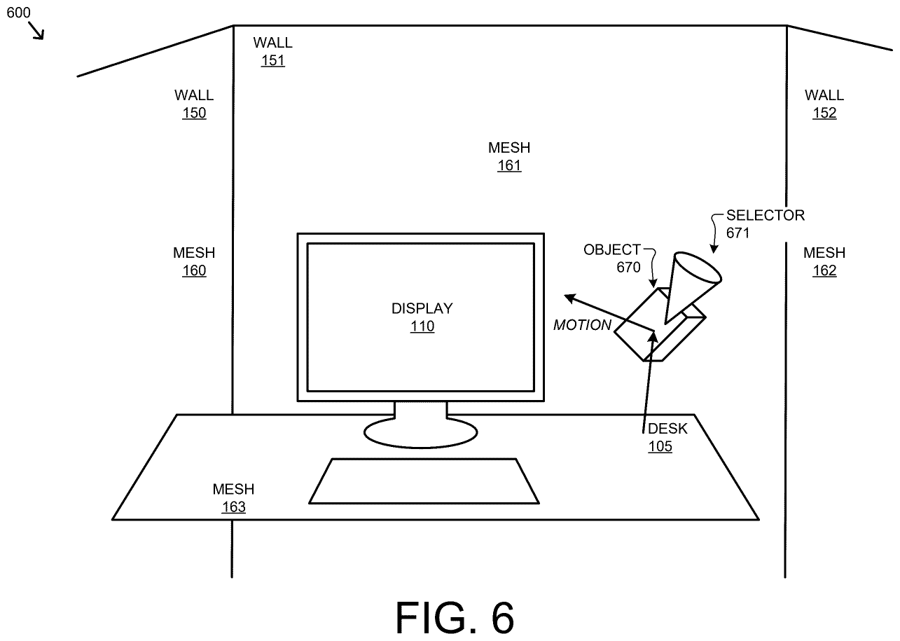

FIG. 6 illustrates an operational scenario 600 of moving an object in 3D space according to an implementation. The operational scenario 600 includes the elements from user perspective 130 of FIG. 1 and further comprises object 670 and selector 671.

In operational scenario 600, object 670, which represents a 3D object displayed by the XR device, is introduced. The user can use a trackpad, mouse, and the like to move selector 671 and select object 670 in the user's perspective. When selected (e.g., clicked using a trackpad), the device can move in 3D space based on the user's inputs. In some implementations, the object moves freely in space. This can permit an object to move without characteristics from the identified meshes. In some examples, this can be a configuration for the object, such that the object is independent of the meshes identified in the environment.

When object 670 moves freely, its transform—which includes its position, rotation, and scale—is disassociated from the coordinate system of any environmental mesh. This means the object is not constrained to the surface of the desk or walls. Instead, user inputs from selector 671 directly manipulate the object's location within the global three-dimensional (3D) world space of the XR environment. For example, a user can drag the object through the open air of the room, and it will maintain its position and orientation relative to the user's perspective, rather than snapping to or conforming with the surfaces of desk 105 or wall 151 as it passes them. This unconstrained movement allows the user to precisely place or inspect the object from any angle in the volumetric space.

In some implementations, the object moves based on the meshes identified for the user environment. For example, when object 670 is selected and placed near desk 105 and mesh 163, the object can be oriented and overlaid as though the object is on top of desk 105. The object can be viewed as though it is sliding on desk 105. When the input indicates an intent to move away from the desk (e.g., moving quickly up), the object can move in space and not be displayed based on the mesh. In some examples, the device can infer intent based on the type of movement. As a technical effect, based on the speed, direction, or other characteristics associated with the user's input, the device can infer whether the object should be displayed based on the characteristics of a mesh or independently of the mesh.

In some examples, the device can be configured with a model that determines the association with the identified meshes of the environment. For example, the model can analyze input characteristics to differentiate between several user intents. If the user selects object 670 and applies a slow, steady movement with a trajectory that remains parallel to the surface of mesh 163, the model can infer an intent to slide the object to a new location on the same surface. In contrast, if the user performs a quick, sharp gesture with a vector directed away from the surface normal of mesh 163, the model can interpret this as an intent to detach object 670 from the mesh and move it into free space. Once detached, if the user moves the object toward wall 151 and its movement decelerates significantly as it nears mesh 161, the model can infer an intent to associate the object with this new mesh.

To determine user intent, a machine learning model can be trained to analyze the characteristics of a user's input in real-time. The model processes a variety of features, including the velocity, acceleration, and trajectory of the selector's movement, as well as contextual data like the direction of the input relative to the surface normal of the mesh and the object's proximity to other meshes. By training on a labeled dataset of user interactions, where specific gestures are mapped to their corresponding outcomes (e.g., “slide on mesh,” “detach,” or “associate with new mesh”), the model learns to differentiate between these intents. Once deployed, it can infer whether a user's gesture is intended to move an object along its current surface, pull it away into free space, or attach it to a different surface, enabling a more fluid and intuitive interaction.

In some implementations, the device can be configured to associate a virtual object (e.g., a virtual screen) with a first mesh, such as mesh 163. The device can further be configured to monitor movement associated with a selection of the virtual object. The movement and selection can be provided via a touchpad, for example. In response to the movement, the device can associate, based on the movement, the virtual object with a location on a second mesh representing a second portion of the physical environment. For example, the user selection and movement via a touchpad can indicate a movement of the virtual object from mesh 163 to mesh 161. This movement can include a movement indicating a withdrawal from mesh 163 and a movement to associate the virtual object with mesh 161 (e.g., move the virtual object toward the mesh). Once associated, the device can further display the virtual object at the location within a display of the XR device. For example, a virtual screen may be displayed as an overlay on wall 150 but can be moved to wall 151 or desk 105.

When a virtual object is associated with a mesh, its orientation can be determined by the geometric properties of that mesh, specifically its surface normal. For example, if a user moves a virtual application window, such as a web browser, from mesh 160 (representing the vertical wall 150) to mesh 163 (representing the (horizontal) desk 105), the system automatically adjusts the window's orientation. While associated with wall 150, the window is displayed upright, its orientation aligned with the vertical surface normal of the wall. Upon being associated with desk 105, the system reorients the window to lie flat, aligning it with the horizontal surface normal of the desk mesh. This automatic adjustment creates a realistic and intuitive effect, as if the user were physically placing the object onto the new surface.

In some implementations, physics parameters can be assigned to meshes to govern how virtual objects interact with them. For example, a mesh can be assigned a friction coefficient based on the material of the physical surface it represents. Consider an application where a user is playing with a virtual toy car. A mesh representing a smooth, wooden surface (e.g., mesh 163) can be assigned a low friction value, allowing the car to roll freely with little resistance. In contrast, if the user moves the car onto a different mesh representing a carpeted area, that mesh can have a much higher friction coefficient. The system's physics engine would use this parameter to realistically slow the car down, simulating the increased resistance of the carpet. This allows the virtual object's behavior to be directly influenced by the characteristics of the real-world environment, thereby enhancing the immersive quality of the experience.

In some implementations, in addition to the physics parameters associated with the mesh, the virtual object itself can be assigned physics parameters that define how the virtual object moves within the environment. For example, a virtual object can be assigned parameters such as mass, a drag coefficient, and a coefficient of restitution (bounciness). These values can be predefined based on the object's type—for instance, a virtual bowling ball would have a high mass and low restitution by default—or the user can customize the values through an interface. To illustrate, consider two virtual spheres placed on the same mesh representing a wooden desk. The first sphere is configured with the physics parameters of a bowling ball (high mass, low restitution), while the second is configured as a rubber ball (low mass, high restitution). If the user applies an identical virtual force to each, the system's physics engine will simulate their distinct behaviors. The bowling ball will accelerate slowly, and the object's movement will be influenced by the desk's friction, while the rubber ball will accelerate quickly and travel farther. Similarly, if both are dropped from the same height onto the desk, the rubber ball will bounce multiple times, whereas the bowling ball will come to a near-immediate stop, demonstrating how the object-specific parameters govern its interaction with the environment.

In some examples, the physics parameters are applied when the virtual object is associated with a particular mesh. For example, when a virtual object is associated with mesh 163 for desk 105 the system's physics engine considers not only the object's parameters but also the specific properties of the mesh. A critical property of mesh 163 is its orientation, defined by its surface normal—a vector pointing vertically upwards, perpendicular to the horizontal tabletop. When the virtual object rests on the desk, the physics engine applies a downward gravitational force proportional to the object's mass. In response, the mesh, being a solid surface, exerts an equal and opposite normal force, preventing the object from passing through. Any user-applied force parallel to this surface will cause the object to slide, with its movement realistically dampened by the friction coefficient assigned to the desk mesh, ensuring that the object's behavior conforms to the physical orientation of the surface it occupies.

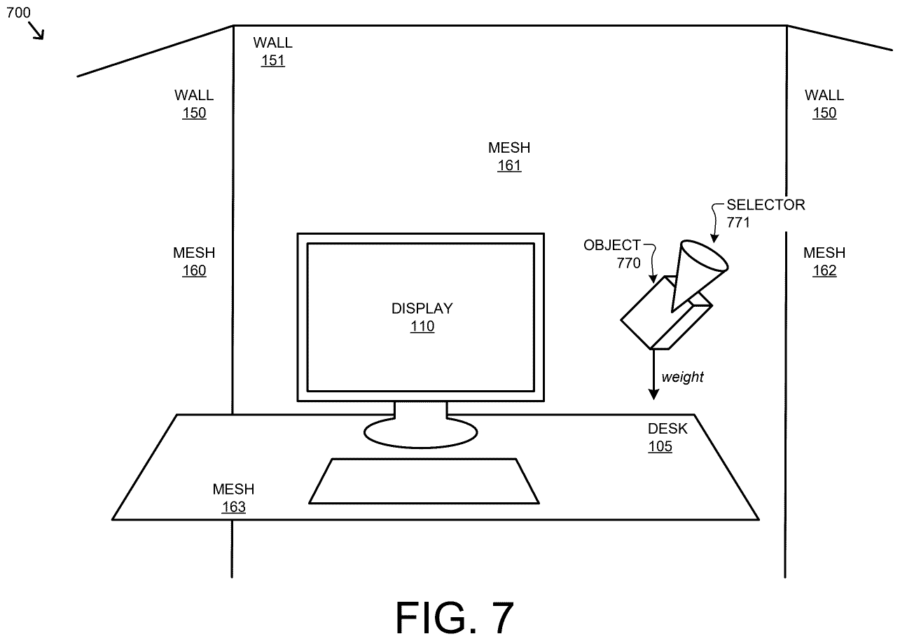

FIG. 7 illustrates an operational scenario 700 of moving an object in 3D space according to an implementation. The operational scenario includes the elements from user perspective 130 of FIG. 1 and further comprises object 770 representative of a virtual object and selector 771 displayed by an XR device.

Operational scenario 700 represents a displayed object with weight characteristics that can be reflected in the object's movement. Suppose the user selects and drops object 770. In that case, the XR device can use physics or a physics engine to determine how the object falls relative to the identified environmental meshes. For example, when a user deselects object 770, the object will fall to desk 105. A physics engine can define the characteristics of the fall. In some implementations, the user can specify the weight of the object, the material of the object, and other attributes of the object. The characteristics define how the object moves in the environment. The user can also indicate that an object moves independently of the meshes, preventing the object from interacting with the meshes.

In some implementations, object 770 can first be associated with a mesh, the mesh having corresponding physics parameters (the object also having physics parameters). For example, when object 770 is moved by selector 771 and placed in association with mesh 163, which represents the surface of desk 105, the system's physics engine governs its behavior based on these combined parameters. If a user applies a force to slide object 770, its movement across the desk will be realistically simulated, decelerating according to its mass and the friction coefficient of the mesh. If the user lifts object 770 into the space above the desk and then releases the selection, the physics engine will apply a gravitational force, causing the object to fall. Upon impact with mesh 163, the object will collide with the solid surface rather than passing through it, potentially bouncing based on its own restitution properties and the physical attributes of the desk before coming to rest.

In some examples, the association of object 770 with mesh 163 can be initiated in several ways, either through direct user action or by default system behavior. For instance, a user can select object 770 while it is in free space using selector 771 and perform a dragging gesture toward desk 105. The system can be configured to monitor the object's trajectory and, upon detecting its proximity to the geometric boundaries of mesh 163, provide a visual cue that an association is possible. When the user releases the selection, the system computationally binds object 770 to mesh 163, causing it to snap to the desk's surface. Alternatively, the association can be a default behavior. If a user instantiates a new object like object 770, the system can be configured to automatically place it on the nearest suitable surface, identifying mesh 163 as a stable, horizontal plane and associating the object with it without requiring explicit user placement. In either case, a model can be used to infer the user's intent to associate the object by analyzing factors such as a deceleration in movement as the object hovers over the mesh or the duration of the selection release gesture.

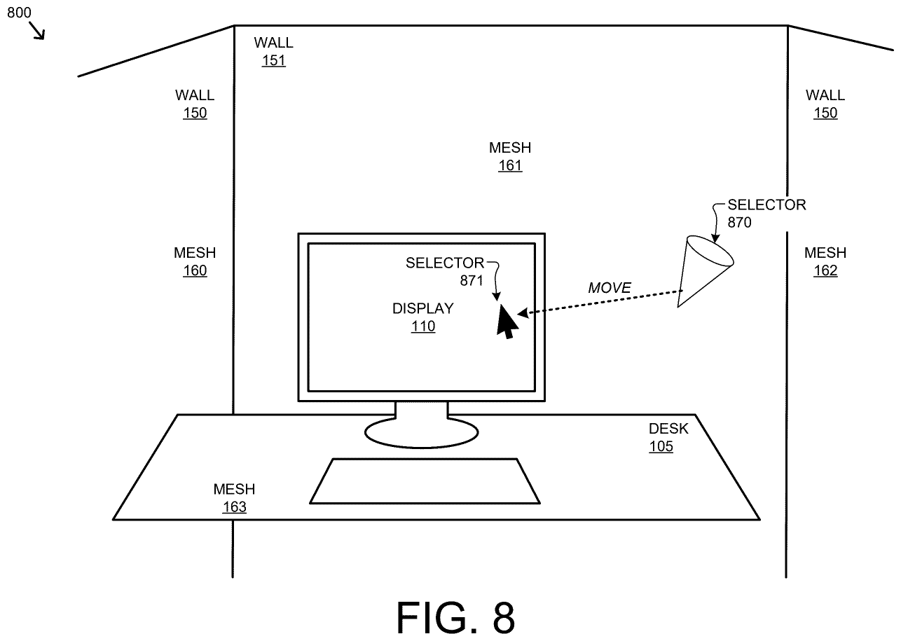

FIG. 8 illustrates an operational scenario 800 of moving a selector in a user's perspective according to an implementation. The operational scenario includes elements from user perspective 130 of FIG. 1 and further comprises selector 870 and selector 871.

In operational scenario 800, based on user input, the XR device determines whether to change from a 3D model of selector 870 to a 2D model of selector 871. For example, the user can use a trackpad to drag selector 870 to the location associated with selector 871. The XR device can determine that the new position is over display 110 and can cause a change in the appearance from the 3D version to the 2D version. In some implementations, an XR device can identify a screen in the physical environment using computer vision and spatial mapping technologies. Cameras and depth sensors can identify flat, rectangular surfaces with edges and corners. Image recognition algorithms can also analyze visual features like aspect ratios, screen bezels, and emitted light patterns. Once identified, the screen's position, orientation, and size are mapped relative to the environment's mesh, enabling the XR device to change the cursor appearance based on the cursor location. In some implementations, the 2D cursor can manipulate the content displayed once over the screen. The technical effect permits the user to distinguish when input will be applied to the content on the screen and when input will be provided outside of the screen.

In some implementations, the user can manually designate a specific mesh as an active working surface. For example, a user may wish to perform several actions on the surface of wall 151. The user can point the selector, which may be in a free-space 3D format, toward wall 151. By performing a specific gesture, such as a long press with a trackpad or a designated voice command, the user can select mesh 161 as the active mesh. In response, the system can provide persistent visual feedback. For instance, a subtle, semi-transparent grid or highlight can be rendered over the entire surface of mesh 161, and the selector 870 might transform into a flat reticle that is constrained to move only along the surface of the selected mesh. This state confirms to the user that wall 151 is the current target surface. Any subsequent action, such as creating a new virtual object, will default to being associated with mesh 161, causing the object to appear directly on the wall without requiring the user to drag it there. The user can then perform another gesture to deselect the mesh, causing the highlight to disappear and the selector to return to its free-space format.

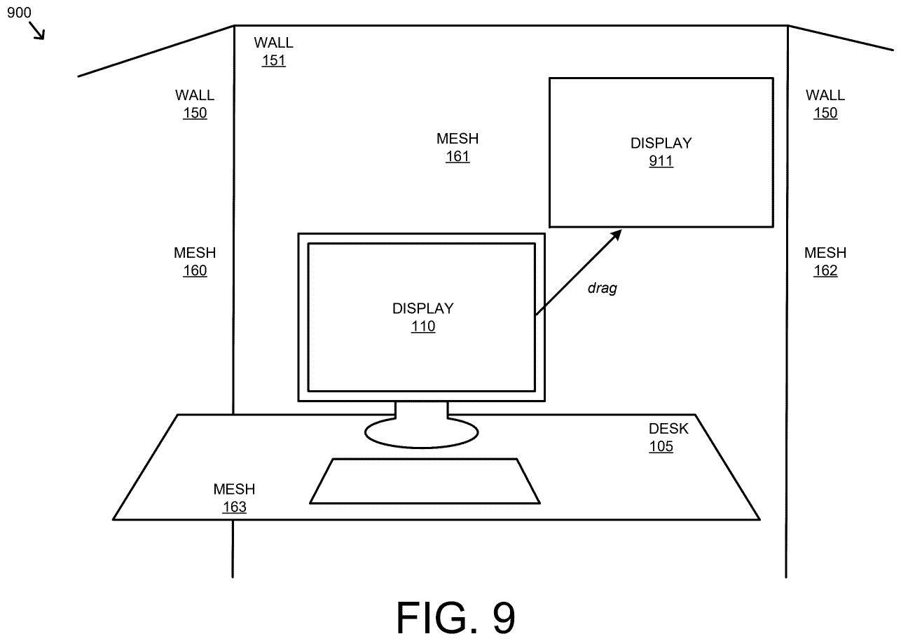

FIG. 9 illustrates an operational scenario 900 of moving displayed content from a display to the virtual space provided by the XR device according to an implementation. The operational scenario includes elements from user perspective 130 of FIG. 1 and further includes display 911.

In operational scenario 900, a user can use a trackpad, mouse, gesture, or other input method to select content from display 110 and move the content to display 911. When moved, the content is displayed based on the mesh on which it was overlaid. For example, the XR device can display the content using spatial mapping. The device scans the environment using sensors and depth cameras, generating a 3D mesh of surfaces like walls, floors, and objects. The device can use the mesh or meshes to anchor digital content by mapping its coordinates to real-world positions. The content can remain stable by leveraging spatial anchors or world-locking features, enabling realistic overlays such as placing on wall 151. The content of display 911 can reflect the properties identified for mesh 161 (angle, distance, etc.). In some implementations, once moved, the content is no longer visible on display 110. In some examples, the content displayed by display 110 corresponds to a second device (e.g., a computer). In some examples, the content displayed by display 110 corresponds to content projected or overlaid on display 110 by the XR device.

To facilitate this transfer, the XR device can be configured to communicate with the host device connected to display 110. For example, a user can move their selector over an application window on display 110. Upon performing a specific gesture, such as a click-and-drag motion directed away from the physical screen, a software agent on the host device captures the state of that window and transmits its content to the XR device. The XR device then instantiates this content as the new virtual object, display 911. Simultaneously, the agent on the host device can minimize or hide the original window, removing it from display 110 to prevent duplication. The reverse is also supported: by dragging the virtual display 911 back onto the display 110 and releasing it, the XR device can send the content back to the agent, which restores the application window on the physical display and signals the XR device to remove the virtual object from the user's view.

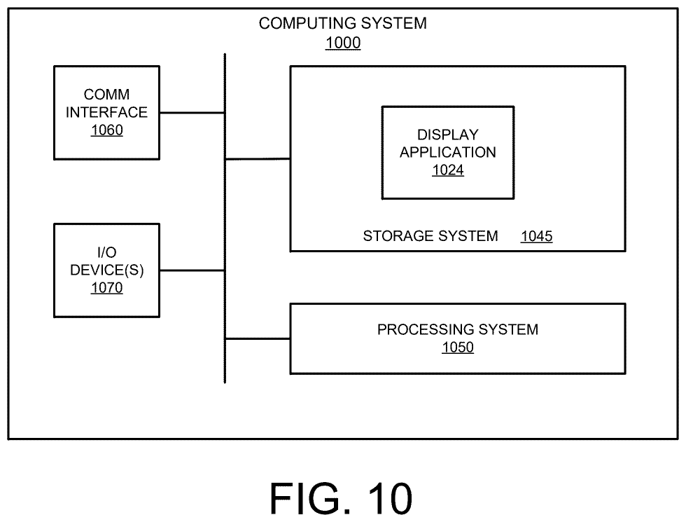

FIG. 10 illustrates a computing system 1000 to manage the display of objects relative to a physical environment according to an implementation. Computing system 1000 represents any computing device or devices with which the various operational architectures, processes, scenarios, and sequences disclosed herein for managing content displayed by an XR device can be implemented. Computing system 1000 is an example of an XR device, head-mounted device, or some other wearable computing device in some examples. Computing system 1000 can include other computing devices in some examples (e.g., desktop computers, smartphones, or other companion devices). Computing system 1000 includes storage system 1045, processing system 1050, communication interface 1060, and input/output (I/O) device(s) 1070. Processing system 1050 is operatively linked to communication interface 1060, I/O device(s) 1070, and storage system 1045. In some implementations, communication interface 1060 and/or I/O device(s) 1070 may be communicatively linked to storage system 1045. Computing system 1000 may further include other components, such as a battery and enclosure, that are not shown for clarity.

Communication interface 1060 comprises components that communicate over communication links, such as network cards, ports, radio frequency, processing circuitry, software, or some other communication devices. Communication interface 1060 may be configured to communicate over metallic, wireless, or optical links. Communication interface 1060 may be configured to use Time Division Multiplex (TDM), Internet Protocol (IP), Ethernet, optical networking, wireless protocols, communication signaling, or some other communication format - including combinations thereof. Communication interface 1060 may be configured to communicate with external devices, such as servers, user devices, or some other computing device.

I/O device(s) 1070 may include computer peripherals that facilitate the interaction between the user and computing system 1000. Examples of I/O device(s) 1070 may include keyboards, mice, trackpads, monitors, displays, printers, cameras, microphones, external storage devices, sensors, and the like.

Processing system 1050 comprises microprocessor circuitry (e.g., at least one processor) and other circuitry that retrieves and executes operating software (i.e., program instructions) from storage system 1045. Storage system 1045 may include volatile and nonvolatile, removable, and non-removable media implemented in any method or technology for storage of information, such as computer-readable instructions, data structures, program modules, or other data. Storage system 1045 may be implemented as a single storage device but may also be implemented across multiple storage devices or sub-systems. Storage system 1045 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 1050 is typically mounted on a circuit board that may hold the storage system. The operating software of storage system 1045 comprises computer programs, firmware, or other forms of machine-readable program instructions. The operating software of storage system 1045 comprises display application 1024. The operating software on storage system 1045 may further include an operating system, utilities, drivers, network interfaces, applications, or some other type of software. When read and executed by processing system 1050 the operating software on storage system 1045 directs computing system 1000 to operate as an XR computing device and display content as described herein. The operating software can provide the operations described in FIGS. 1-9 in at least one implementation.

In at least one implementation, display application 1024 directs processing system 1050 to implement the operations for managing virtual content. In some examples, display application 1024 processes sensor data, including image and depth data, received from I/O device(s) 1070 to determine a first mesh and a second mesh. These meshes serve as digital representations of distinct portions of the physical environment, such as a desk and a wall. The application then associates a virtual object with the first mesh by computationally binding the object's spatial properties to the mesh's coordinate system, causing the object to be rendered as if it were anchored to the corresponding physical surface.

Furthermore, display application 1024 is configured to monitor and interpret user interactions with the virtual object. When a user selects the object using an input from I/O device(s) 1070, the application identifies the subsequent movement by analyzing its characteristics, such as velocity, acceleration, and trajectory relative to the mesh. Based on this analysis, the application infers user intent. For example, a sharp pulling motion away from the surface can be identified as an intent to detach the object, while a slower movement toward a different surface can be identified as an intent to re-associate it.

Based on the identified movement, display application 1024 can associate the virtual object with a new location on the second mesh. This process involves unbinding the object from the first mesh and re-binding its transform to the coordinate system of the second mesh. As part of this operation, the application determines the proper orientation for the virtual object, aligning it with the surface normal of the second mesh. For instance, an object moved from a horizontal desk mesh to a vertical wall mesh will automatically be reoriented from a flat to an upright position. Once the new association and orientation are set, the application directs the processing system 1050 to display the virtual object at the new location.

In some implementations, display application 1024 also manages the physical behavior of virtual objects. The application can determine or receive physics attributes associated with a virtual object, such as mass and elasticity, as well as attributes for the meshes, such as friction or restitution. When displaying the virtual object, its interactions with the meshes are governed by these attributes and simulated by a physics engine. This enables realistic behaviors, such as an object sliding with appropriate friction across a surface or bouncing upon impact, thereby creating a more intuitive and immersive user experience.

In some implementations, display application 1024 also manages the visual format of the selector based on its interaction context. The format of the selector changes dynamically based on whether it is associated with a specific mesh or moving freely in 3D space. For instance, when a user moves the selector over a first mesh, such as a desk, display application 1024 can render the selector in a first format, such as a flat, circular reticle that is oriented to align with the surface normal of the desk mesh. This provides a clear visual affordance that the selector is constrained to the two-dimensional surface of the desk.

In response to a user input indicating an intent to disassociate from the mesh, such as a quick pulling gesture away from the surface, display application 1024 can change the selector to a second format, such as a three-dimensional volumetric pointer or a directional ray. This second format signals that the selector is now in free space, disassociated from any mesh, and capable of unconstrained movement in three axes. As the user moves this 3D selector toward a second mesh with a different orientation, such as a vertical wall, the system can detect its proximity. Upon a user action to associate the selector with the wall, display application 1024 re-associates the selector and updates its appearance to conform to the new surface, rendering it again as a flat reticle, but now oriented vertically against the wall mesh.

Below are example clauses associated with the present disclosure. The described clauses should not be considered exhaustive.

Clause 1. A method comprising: determining a first mesh representing a first portion of a physical environment; associating a virtual object with the first mesh; identifying a movement associated with a selection of the virtual object; associating, based on the movement, the virtual object with a location on a second mesh representing a second portion of the physical environment; and displaying the virtual object at the location within a display of an extended reality device.

Clause 2. The method of clause 1, wherein the movement comprises a first movement, and the method further comprising: identifying a second movement associated with a second selection of the virtual object; moving the virtual object from the location to a second location on the second mesh based on the second movement.

Clause 3. The method of clause 1, wherein the movement comprises a first movement, and the method further comprising: identifying a second movement associated with a second selection of the virtual object; and moving the virtual object from the location to a second location separate from the second mesh and the first mesh.

Clause 4. The method of clause 1, wherein determining the first mesh comprises: receiving sensor data from at least one sensor; determining the first mesh based on the sensor data from the at least one sensor.

Clause 5. The method of clause 4, wherein the sensor data comprises image data and/or depth data.

Clause 6. The method of clause 1 further comprising: determining an orientation of the virtual object on the display of the extended reality device based on the movement, wherein displaying the virtual object at the location includes displaying the virtual object at the location with the orientation.

Clause 7. The method of clause 1 further comprising: determining physics attributes associated with the virtual object, wherein displaying the virtual object at the location includes displaying the virtual object at the location based on the physics attributes.

Clause 8. The method of clause 1 further comprising: associating a selector associated with the selection and the movement with the second mesh; displaying the selector based on the second mesh.

Clause 9. A computer-readable storage medium having program instructions stored thereon that, when executed by at least one processor, direct the at least one processor to perform a method, the method comprising: determining a first mesh representing a first portion of a physical environment; associating a virtual object with the first mesh; identifying a movement associated with a selection of the virtual object; associating, based on the movement, the virtual object with a location on a second mesh representing a second portion of the physical environment; and displaying the virtual object at the location within a display of an extended reality device.

Clause 10. The computer-readable storage medium of clause 9, wherein the movement comprises a first movement, and the method further comprising: identifying a second movement associated with a second selection of the virtual object; moving the virtual object from the location to a second location on the second mesh based on the second movement.

Clause 11. The computer-readable storage medium of clause 9, wherein the movement comprises a first movement, and the method further comprising: identifying a second movement associated with a second selection of the virtual object; and moving the virtual object from the location to a second location separate from the second mesh and the first mesh.

Clause 12. The computer-readable storage medium of clause 9, wherein determining the first mesh comprises: receiving sensor data from at least one sensor; determining the first mesh based on the sensor data from the at least one sensor.

Clause 13. The computer-readable storage medium of clause 12, wherein the sensor data comprises image data and/or depth data.

Clause 14. The computer-readable storage medium of clause 9, wherein the method further comprises: determining an orientation of the virtual object on the display of the extended reality device based on the movement, wherein displaying the virtual object at the location includes displaying the virtual object at the location with the orientation.

Clause 15. The computer-readable storage medium of clause 9, wherein the method further comprises: determining physics attributes associated with the virtual object, wherein displaying the virtual object at the location includes displaying the virtual object at the location based on the physics attributes.

Clause 16. A computing system comprising: a computer-readable storage medium; at least one processor operatively coupled to the computer-readable storage medium; and program instructions stored on the computer-readable storage medium that, when executed by the at least one processor, direct the computing system to perform a method, the method comprising: determining a first mesh representing a first portion of a physical environment; associating a virtual object with the first mesh; identifying a movement associated with a selection of the virtual object; associating, based on the movement, the virtual object with a location on a second mesh representing a second portion of the physical environment; and displaying the virtual object at the location within a display of an extended reality device.

Clause 17. The computing system of clause 16, wherein the movement comprises a first movement, and the method further comprising: identifying a second movement associated with a second selection of the virtual object; moving the virtual object from the location to a second location on the second mesh based on the second movement.

Clause 18. The computing system of clause 16, wherein the movement comprises a first movement, and the method further comprising: identifying a second movement associated with a second selection of the virtual object; and moving the virtual object from the location to a second location separate from the second mesh and the first mesh.

Clause 19. The computing system of clause 16, wherein determining the first mesh comprises: receiving sensor data from at least one sensor; determining the first mesh based on the sensor data from the at least one sensor.

Clause 20. The computing system of clause 16, wherein the method further comprises: determining an orientation of the virtual object on the display of the extended reality device based on the movement, wherein displaying the virtual object at the location includes displaying the virtual object at the location with the orientation.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
determining a first mesh representing a first portion of a physical environment;
associating a virtual object with the first mesh;
identifying a movement associated with a selection of the virtual object;
associating, based on the movement, the virtual object with a location on a second mesh representing a second portion of the physical environment; and
displaying the virtual object at the location within a display of an extended reality device.

2. The method of claim 1, wherein the movement comprises a first movement, and the method further comprising:
identifying a second movement associated with a second selection of the virtual object; and
moving the virtual object from the location to a second location on the second mesh based on the second movement.

3. The method of claim 1, wherein the movement comprises a first movement, and the method further comprising:
identifying a second movement associated with a second selection of the virtual object; and
moving the virtual object from the location to a second location separate from the second mesh and the first mesh.

4. The method of claim 1, wherein determining the first mesh comprises:
receiving sensor data from at least one sensor; and
determining the first mesh based on the sensor data from the at least one sensor.

5. The method of claim 4, wherein the sensor data comprises image data and/or depth data.

6. The method of claim 1 further comprising:
determining an orientation of the virtual object on the display of the extended reality device based on the movement,
wherein displaying the virtual object at the location includes displaying the virtual object at the location with the orientation.

7. The method of claim 1 further comprising:
determining physics attributes associated with the virtual object,
wherein displaying the virtual object at the location includes displaying the virtual object at the location based on the physics attributes.

8. The method of claim 1 further comprising:
associating a selector associated with the selection and the movement with the second mesh; and
displaying the selector based on the second mesh.

9. A computer-readable storage medium having program instructions stored thereon that, when executed by at least one processor, direct the at least one processor to perform a method, the method comprising:
determining a first mesh representing a first portion of a physical environment;
associating a virtual object with the first mesh;
identifying a movement associated with a selection of the virtual object;
associating, based on the movement, the virtual object with a location on a second mesh representing a second portion of the physical environment; and
displaying the virtual object at the location within a display of an extended reality device.

10. The computer-readable storage medium of claim 9, wherein the movement comprises a first movement, and the method further comprising:
identifying a second movement associated with a second selection of the virtual object; and
moving the virtual object from the location to a second location on the second mesh based on the second movement.

11. The computer-readable storage medium of claim 9, wherein the movement comprises a first movement, and the method further comprising:
identifying a second movement associated with a second selection of the virtual object; and
moving the virtual object from the location to a second location separate from the second mesh and the first mesh.

12. The computer-readable storage medium of claim 9, wherein determining the first mesh comprises:
receiving sensor data from at least one sensor; and
determining the first mesh based on the sensor data from the at least one sensor.

13. The computer-readable storage medium of claim 12, wherein the sensor data comprises image data and/or depth data.

14. The computer-readable storage medium of claim 9, wherein the method further comprises:
determining an orientation of the virtual object on the display of the extended reality device based on the movement,
wherein displaying the virtual object at the location includes displaying the virtual object at the location with the orientation.

15. The computer-readable storage medium of claim 9, wherein the method further comprises:
determining physics attributes associated with the virtual object,
wherein displaying the virtual object at the location includes displaying the virtual object at the location based on the physics attributes.

16. A computing system comprising:
a computer-readable storage medium;
at least one processor operatively coupled to the computer-readable storage medium; and
program instructions stored on the computer-readable storage medium that, when executed by the at least one processor, direct the computing system to perform a method, the method comprising:
determining a first mesh representing a first portion of a physical environment;
associating a virtual object with the first mesh;
identifying a movement associated with a selection of the virtual object;
associating, based on the movement, the virtual object with a location on a second mesh representing a second portion of the physical environment; and
displaying the virtual object at the location within a display of an extended reality device.

17. The computing system of claim 16, wherein the movement comprises a first movement, and the method further comprising:
identifying a second movement associated with a second selection of the virtual object; and
moving the virtual object from the location to a second location on the second mesh based on the second movement.

18. The computing system of claim 16, wherein the movement comprises a first movement, and the method further comprising:
identifying a second movement associated with a second selection of the virtual object; and
moving the virtual object from the location to a second location separate from the second mesh and the first mesh.

19. The computing system of claim 16, wherein determining the first mesh comprises:
receiving sensor data from at least one sensor; and
determining the first mesh based on the sensor data from the at least one sensor.

20. The computing system of claim 16, wherein the method further comprises:
determining an orientation of the virtual object on the display of the extended reality device based on the movement,
wherein displaying the virtual object at the location includes displaying the virtual object at the location with the orientation.
